(19) United States
(12) Patent Application Publication
(10) Pub. No.: US 2026/0316624 A1
(43) Pub. Date: Oct. 15, 2026

(54) INFORMATION PROCESSING APPARATUS

(71) Applicant: TOYOTA JIDOSHA KABUSHIKI KAISHA, Toyota-shi (JP)

(72) Inventor: Koki MORI, Inuyama-shi (JP)

(73) Assignee: TOYOTA JIDOSHA KABUSHIKI KAISHA, Toyota-shi (JP)

(21) Appl. No.: 19/466,240

(22) Filed: Jan. 30, 2026

(30) Foreign Application Priority Data
Mar. 25, 2025 (JP) 2025-050716

(51) Int. Cl. B60L 58/12; B60L 53/66; B60R 16/033

(52) U.S. Cl. CPC B60L 58/12; B60L 53/66; B60R 16/033

(57) ABSTRACT

The information processing apparatus includes a controller that manages charging of a vehicle with one or more remote service functions that can be remotely operated by a user. The controller acquires operation data on the vehicle, predicts the user's next boarding time based on the operation data upon detecting that an ignition switch of the vehicle is turned off, and forecasts whether the vehicle enters a power-saving mode for suppressing power consumption of the vehicle by the predicted next boarding time. When the vehicle is forecast to enter the power-saving mode, the controller identifies a remote service function whose use is to be restricted in the power-saving mode, and performs control to notify the user of a warning.

### CROSS-REFERENCE TO RELATED APPLICATION

This application claims priority to Japanese Patent Application No. 2025-050716 filed on Mar. 25, 2025, the entire contents of which are incorporated herein by reference.

### TECHNICAL FIELD

The present disclosure relates to an information processing apparatus.

### BACKGROUND

A remote service has been provided that enables users to remotely check the status of vehicles, operate devices mounted in the vehicles, and perform other similar operations. Patent Literature (PTL) 1 discloses a remote control operation service performance apparatus that determines, based on a state of a storage battery unit that supplies electric power to the on-board vehicle device, whether to perform the operation control of the on-board vehicle device.

### CITATION LIST

### Patent Literature

PTL 1: JP 2005-094092 A

### SUMMARY

When a vehicle has a reduced remaining battery level, a “power-saving mode” is activated, in which some or all functions of the vehicle are restricted and energy use is optimized to reduce battery consumption. Remote service functions include, for example, remote check for checking the position and the like of the vehicle, remote operation for unlocking and locking doors and windows, remote start for activating air conditioning and other devices, and the like. When the “power-saving mode” is activated, some remote service functions that a user wants to use may be restricted and unavailable.

To prevent restriction of the remote service functions, it is conceivable to charge the vehicle so as to prevent a reduction in the remaining battery level and avoid activation of the “power-saving mode.” However, the time required for charging can sometimes be a burden in daily life. Additionally, excessive charging cycles may shorten the battery's life, which is undesirable. Therefore, it is necessary to appropriately plan a charging schedule, such as by avoiding unnecessary charging.

It would be helpful to facilitate planning an appropriate charging schedule.

An information processing apparatus according to an embodiment of the present disclosure is an information processing apparatus including a controller configured to manage charging of a vehicle with one or more remote service functions that can be remotely operated by a user, wherein the controller is configured to:
acquire operation data on the vehicle;
predict a next boarding time based on the operation data upon detecting that an ignition switch of the vehicle is turned off;
forecast whether the vehicle enters a power-saving mode for suppressing power consumption of the vehicle by the predicted next boarding time; and
when the vehicle is forecast to enter the power-saving mode, identify a remote service function whose use is to be restricted in the power-saving mode, and perform control to notify the user of a warning.

The present disclosure facilitates planning an appropriate charging schedule.

### BRIEF DESCRIPTION OF THE DRAWINGS

In the accompanying drawings:

FIG. 1 is a diagram illustrating a configuration of a system according to an embodiment of the present disclosure; and

FIG. 2 is a flowchart illustrating operations of an information processing apparatus according to an embodiment of the present disclosure.

### DETAILED DESCRIPTION

Hereinafter, an embodiment of the present disclosure will be described with reference to the drawings.

In the drawings, the same or corresponding portions are denoted by the same reference numerals. In the descriptions of the present embodiment, detailed descriptions of the same or corresponding portions are omitted or simplified as appropriate.

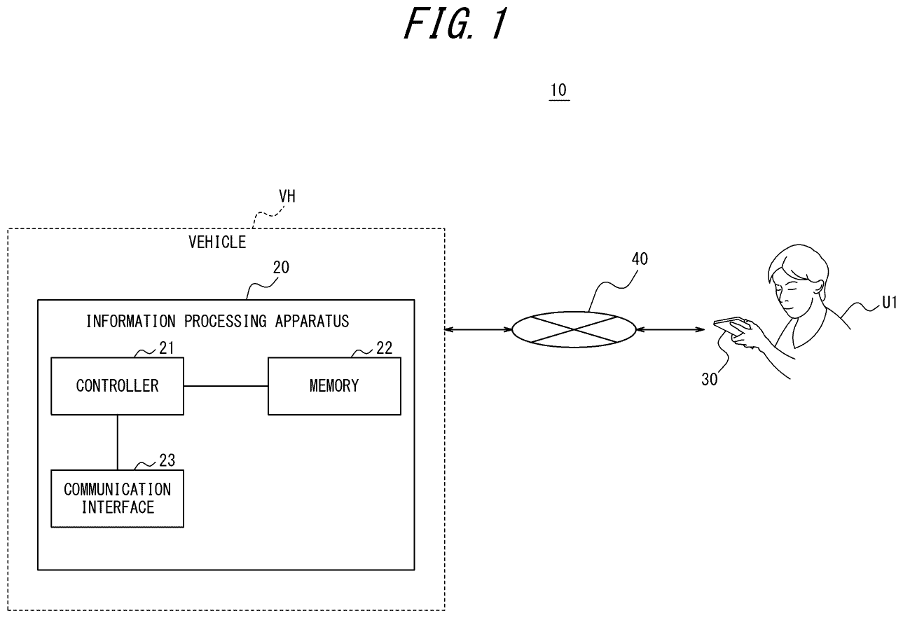

A configuration of a system 10 according to the present embodiment will be described with reference to FIG. 1.

The system 10 includes an information processing apparatus 20 and a terminal apparatus 30. The information processing apparatus 20 can communicate with the terminal apparatus 30 via a network 40 such as the Internet.

The information processing apparatus 20 is a terminal device installed in the vehicle VH. The information processing apparatus 20 may be, for example, a car navigation device, a mobile phone, a smartphone, a tablet, a PC, or an in-vehicle CDC. The term “PC” is an abbreviation of personal computer. “CDC” is an abbreviation for Cockpit Domain Controller.

The vehicle VH is an EV in the present embodiment, but may be any type of automobile that requires charging, such as a BEV, HV, PHV, or FCV. The term “EV” is an abbreviation of electric vehicle. The term “BEV” is an abbreviation of battery electric vehicle. The term “HV” is an abbreviation of hybrid vehicle. The term “PHV” is an abbreviation of plug-in hybrid vehicle. The term “FCV” is an abbreviation of fuel cell vehicle.

The terminal apparatus 30 is held by the user U1. The terminal apparatus 30 may be, for example, a mobile phone, a smartphone, a tablet, or a PC.

An outline of the present embodiment will be described with reference to FIG. 1.

The vehicle VH has one or more remote service functions that can be remotely operated by the user U1. The information processing apparatus 20 that manages the charging of the vehicle VH acquires the operation data D1 of the vehicle VH, and when it detects that the ignition switch of the vehicle VH is turned off, it predicts the next boarding time T1 of the user U1 based on the operation data D1. The information processing apparatus 20 predicts whether it will enter a power-saving mode by the predicted next boarding time T1, in order to suppress the power consumption of the vehicle VH. When it is predicted that the information processing apparatus 20 will enter the power-saving mode, it identifies the remote service functions whose use is to be restricted in the power-saving mode and performs control to notify the user U1 of a warning W.

According to the present embodiment, when it is expected that the vehicle VH will enter the power-saving mode, it can notify the user U1 as a warning W that there are remote service functions whose use will be restricted until the next boarding time T1. Therefore, the occurrence of inconveniences such as the vehicle VH being in power-saving mode and unavailable when the user U1 wants to use the remote service functions is reduced, thus improving the convenience of the system 10. Also, if it is predicted that the vehicle will not enter the power-saving mode, or if there are no remote service functions whose use is restricted in the power-saving mode, no notification will be made to the user U1, and they will not be prompted to charge. Thus, it is possible to prevent excessive charging and make it easier to properly plan the charging schedule.

A configuration of the information processing apparatus 20 according to the present embodiment will be described with reference to FIG. 1.

The information processing apparatus 20 includes a controller 21, a memory 22, and a communication interface 23.

The controller 21 includes at least one processor, at least one programmable circuit, at least one dedicated circuit, or any combination thereof.

The memory 22 includes at least one semiconductor memory, at least one magnetic memory, at least one optical memory, or any combination thereof. In the present embodiment, the memory 22 stores a database DB that associates and registers the functions of the vehicle VH that are restricted in the power-saving mode.

The communication interface 23 includes at least one interface for communication.

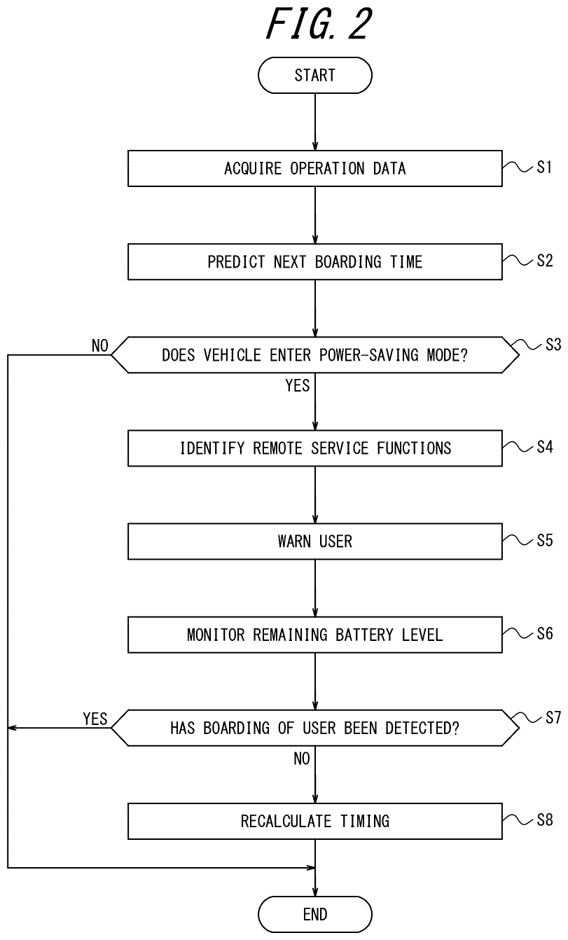

Operations of the system 10 according to the present embodiment will be described with reference to FIG. 2.

In S1, the controller 21 of the information processing apparatus 20 acquires the operation data D1 of the vehicle VH collected using sensors mounted on the vehicle VH. Operation data D1 is, for example, information indicating the days and/or time periods when user U1 has used vehicle VH in the past, and is learned in advance for each user. As an example, operation data D1 shows the usage pattern of vehicle VH learned for user U1, such as “weekdays from 7:00 to 8:00 AM, after 10:00 AM on holidays” as the days and/or time periods when user U1 uses vehicle VH.

In S2, when the controller 21 of the information processing apparatus 20 detects that the ignition switch of vehicle VH has been turned off, it predicts the next boarding time T1 for user U1 based on operation data D1. Specifically, the controller 21 analyzes operation data D1 and predicts the next boarding time T1 based on the past usage pattern of vehicle VH by user U1 indicated by operation data D1.

In S3, the controller 21 of the information processing apparatus 20 predicts whether vehicle VH will enter power-saving mode by the next boarding time T1. This prediction can be made by any procedure, but is performed, for example, in the following manner. The controller 21 calculates the timing T2 for entering power-saving mode based on the remaining battery level r1 at the time when the ignition switch of vehicle VH is turned off. The controller 21 calculates the timing T2 as the timing when the battery level R of vehicle VH falls below a predetermined threshold Th. The threshold Th can be set arbitrarily, but is generally set between 20% and 30% considering the balance between vehicle safety and efficient power management. The threshold Th may be customized by user U1. Timing T2 can be determined by calculating the remaining operating time t until reaching the threshold Th, considering the remaining battery level r1. The remaining operating time t can be calculated by subtracting the threshold Th from the remaining battery level r1 and dividing the result by the natural discharge rate of the battery and the standby power consumption of vehicle VH. The controller 21 predicts that it will enter power-saving mode if timing T2 is earlier than the next boarding time T1. In S3, if it is predicted that it will enter power-saving mode, the process of S4 is performed, and if it is predicted that it will not enter, the controller 21 ends the process.

In S4, the controller 21 of the information processing apparatus 20 identifies the remote service functions whose use is restricted in power-saving mode. In this embodiment, the types of functions of vehicle VH that are restricted when entering power-saving mode are predetermined and stored in the memory 22 in the form of a database DB. The controller 21 refers to the database DB read from the memory 22 to identify the remote service functions whose use is restricted. As an example, the database DB may store “remote operation” associated with power-saving mode. The controller 21 refers to the database DB and identifies “remote operation” as the remote service function whose use is restricted. The functions whose use is restricted in power-saving mode may be defined arbitrarily, but can be determined according to the type of function, for example. For example, functions related to the safety of the vehicle, such as door locking, should ideally not be restricted as much as possible. Alternatively, the functions whose use is to be restricted may be determined according to the type of vehicle VH. This is because, depending on the type of vehicle VH, the auxiliary battery may be revived by starting the engine. Additionally, the “power-saving mode” may be set in multiple stages according to the value of the remaining battery level R. For example, as the remaining battery level R decreases, “power-saving mode A”, “power-saving mode B”, etc. may be set in stages, and the number of remote service functions whose use is to be restricted may be increased in this order.

In S5, the controller 21 of the information processing apparatus 20 performs control to notify the user U1 of a warning W. For example, the controller 21 generates a message M1 as a warning W, stating, “There are remote service functions that will not be available until your next boarding. Please charge the vehicle.” and sends it to the terminal apparatus 30 of the user U1 via the communication interface 23. The controller 21 may notify the user U1 of the types of functions whose use is to be restricted. The controller 21 may notify the warning W by displaying the message M1 on in-vehicle displays such as the multimedia center display mounted in the vehicle VH, car navigation, or the meter screen. The warning W may be notified not only in text but also by voice. The warning W may be notified at any timing, but it is preferable that it is notified before the user U1 gets off or while boarding. This way, for example, if the user U1 has charging facilities at home, it is convenient as they can charge the vehicle directly. Alternatively, as will be described later, if the controller 21 of the information processing apparatus 20 is monitoring the remaining battery level R of the vehicle VH, the warning W may be notified at the timing when the user U1 opens the terminal apparatus 30 between getting off and the next boarding time T1. The user U1 who has been notified of the warning W can take actions such as charging the vehicle VH to prevent the vehicle VH from entering power-saving mode.

As a variation of the present embodiment, the controller 21 of the information processing apparatus 20 may acquire history data D2 showing the usage history of one or more remote service functions by the user U1 and determine whether to notify the warning W based on the acquired history data D2. Specifically, the controller 21 may refer to the history data D2 to calculate the usage frequency f of the remote service functions whose use is to be restricted by the user U1 and determine whether to notify the warning W based on the usage frequency f. The history data D2 may include data that records the types of remote service functions used by the user U1 as usage history and the timing of such usage, and the controller 21 may calculate the usage frequency f for each time period until the next boarding time T1. The controller 21 may notify the warning W only when the usage frequency f of the remote service functions whose use is to be restricted is above a predetermined value. As an example, if the remote service function whose use is to be restricted is “remote check” and the calculated usage frequency f for “remote check” is lower than a predetermined value, the warning W may not be notified. According to this variation, even if the vehicle VH enters power-saving mode, if the usage frequency of the remote service functions whose use is to be restricted is expected to be low, no notification will be made to the user U1. As a result, unnecessary charging can be prevented, making it easier to plan the charging schedule more appropriately.

As a further variation of this variation example, the history data D2 may include data that associates the types of remote service functions used by user U1 with the external environment at the time of use as usage history. The external environment includes, for example, climate, season, weather, and outside temperature. The controller 21 of the information processing apparatus 20 acquires environmental data d1 indicating the forecast of the external environment of the vehicle VH until the next boarding time T1 (for example, weather forecast, etc.), and may adjust the usage frequency f based on the environmental data d1. Specifically, the controller 21 weights the usage frequency f calculated for the remote service functions associated with the forecast of the external environment indicated by the environmental data d1. For example, if the external environment is “snow,” user U1 may use “remote start” among the remote service functions to activate heating and defroster functions. As a result, the usage history will include data that associates “remote start” with “snow.” In this example, for instance, if the environmental data d1 indicates a “snow forecast,” the controller 21 will weight the usage frequency f′ for “remote start” stored in the history data D2 associated with “snow.” As a result, when snow is expected, the usage frequency f′ of “remote start” is preferentially set high, and it is determined whether to notify a warning W based on the usage frequency f′. According to this variation example, it is possible to notify a warning W according to the needs of user U1 that change according to the external environment, thereby reducing cases where user U1 cannot utilize the remote service functions they want to use.

As another variation of this embodiment, the controller 21 of the information processing apparatus 20 may monitor the battery level R of the vehicle VH from the time user U1 gets off the vehicle until the next boarding time T1. Then, if no boarding of user U1 to the vehicle VH is detected by the next boarding time T1, the controller 21 may recalculate the timing T2 based on the battery level r2 at the next boarding time T1 and the battery consumption rate, and notify the recalculated timing T2′ to user U1. Specifically, the controller 21 may further perform the processes S6 to S8 shown in FIG. 2.

In S6, when the controller 21 detects that user U1 has gotten off, it starts monitoring the battery level R and continues monitoring until the next boarding time T1.

In S7, the controller 21 of the information processing apparatus 20 determines whether the boarding of user U1 to the vehicle VH has been detected by the next boarding time T1. The boarding of user U1 to the vehicle VH can be detected based on information from various sensors. When the boarding of user U1 is detected in S8, the controller 21 ends the process, and if no boarding is detected, it performs the process of S8.

In S8, the controller 21 of the information processing apparatus 20 recalculates the timing T2 based on the battery level r2 at the next boarding time T1 and the battery consumption rate, and performs control to notify the recalculated timing T2′ to user U1.

According to this variation example, even if user U1 cannot return to the vehicle VH as initially planned, the timing T2′ for the vehicle VH to enter the power-saving mode is notified to user U1. User U1 who receives the notification can take measures, for example, to return early before the vehicle VH enters the power-saving mode. Accordingly, the convenience of the system improves.

In the above-described embodiment, it was explained that some or all functions of the information processing apparatus 20 are mounted on the vehicle VH, but the information processing apparatus 20 may be installed outside the vehicle VH, and the information processing apparatus 20 and the vehicle VH may process while transmitting and receiving various data via the network 40. In this case, the information processing apparatus 20 may be a server apparatus belonging to a cloud computing system, such as one installed in a data center.

The present disclosure is not limited to the embodiment described above. Modifications can be made without departing from the spirit of the present disclosure.

1. An information processing apparatus comprising a controller configured to manage charging of a vehicle with one or more remote service functions that can be remotely operated by a user, wherein the controller is configured to:
acquire operation data on the vehicle, the operation data being collected using a sensor mounted in the vehicle;
upon detecting that an ignition switch of the vehicle is turned off, predict the user's next boarding time by analyzing the operation data;
forecast whether the vehicle enters a power-saving mode by the next boarding time, based on a remaining battery level at a time when the ignition switch is turned off, the power-saving mode being for suppressing power consumption of the vehicle by restricting use of some or all of functions of the vehicle including the one or more remote service functions; and
when the vehicle is forecast to enter the power-saving mode, identify a remote service function whose use is to be restricted, among the one or more remote service functions, with reference to a database in which functions of the vehicle whose use are to be restricted are registered as associated with the power-saving mode, and perform control to notify the user's terminal apparatus of a warning.

2. An information processing apparatus comprising a controller configured to manage charging of a vehicle with one or more remote service functions that can be remotely operated by a user, wherein the controller is configured to:
acquire operation data on the vehicle;
predict a next boarding time based on the operation data upon detecting that an ignition switch of the vehicle is turned off;
forecast whether the vehicle enters a power-saving mode for suppressing power consumption of the vehicle by the predicted next boarding time; and
when the vehicle is forecast to enter the power-saving mode, identify a remote service function whose use is to be restricted in the power-saving mode, and perform control to notify the user of a warning.

3. The information processing apparatus according to claim 1, wherein the controller is configured to:
acquire history data indicating a usage history of the one or more remote service functions by the user;
calculate, with reference to the acquired history data, a usage frequency by the user for the remote service function whose use is to be restricted; and
determine whether to notify the warning, depending on the calculated usage frequency.

4. The information processing apparatus according to claim 3, wherein
the history data includes, as the usage history, data storing a type of a remote service function used by the user as associated with an external environment when that remote service function has been used, and
the controller is configured to acquire environmental data indicating a forecast of an external environment of the vehicle until the next boarding time, and adjust the usage frequency based on the acquired environmental data.

5. The information processing apparatus according to claim 1, wherein the controller is configured to:
calculate timing of entering the power-saving mode based on the remaining battery level at the time when the ignition switch is turned off; and
forecast that the vehicle enters the power-saving mode when the calculated timing is earlier than the next boarding time.

6. The information processing apparatus according to claim 5, wherein the controller is configured to:
monitor the remaining battery level of the vehicle from a time when the user gets off the vehicle until the next boarding time; and
when the user's boarding the vehicle is not detected by the next boarding time, re-calculate the timing based on the remaining battery level and a battery consumption rate at the next boarding time; and
perform control to notify the user of the re-calculated timing.
